(19) United States
(12) Patent Application Publication
(10) Pub. No.: US 2020/0047684 A1
(43) Pub. Date: Feb. 13, 2020

(54) Base Mat for Suction Cup Mount

(71) Applicant: Sen Cai, Hayward, CA (US)

(72) Inventor: Sen Cai, Hayward, CA (US)

(21) Appl. No.: 16/535,743

(22) Filed: Aug. 8, 2019

Related U.S. Application Data
(60) Provisional application No. 62/715,989, filed on Aug. 8, 2018.

(51) Int. Cl. B60R 11/02; C09J 7/26; F16M 13/02

(52) U.S. Cl. CPC B60R 11/02; C09J 7/26; B60R 2011/0003; C09J 2400/243; F16M 13/02

(57) ABSTRACT

A base mat for attaching a suction cup mounting device to in a vehicle. The base mat comprises a planar surface made from a substantially rigid material and having first and second faces, first and second foam adhesive strips fixed along edges of the first face of the planar surface, and an optional third foam adhesive strip positioned on the first face of the planar surface between the first and second strips.

### TECHNICAL FIELD OF THE INVENTION

The present invention relates to base devices used to secure suction cup mounts. More specifically, the present invention relates to a method and device for providing a base, preferably within a vehicle, to which a suction cup mount can be readily secured.

### BACKGROUND OF THE INVENTION

The use of a mounting device within a vehicle to secure a phone, GPS device, notepad, or similar item, is well-known. Typically, the mounting device includes a connector at one end by which the item (e.g., phone, etc.) can be securely attached, and a second connector at another end by which the device and secured item are securely attached to a surface (e.g., dashboard) within a vehicle. The second connector can be a permanent attachment, in which case the mounting device cannot be readily removed for repositioning in the vehicle or for placement in another vehicle. Alternatively, the second connector can be temporary attached to permit easy removal and repositioning, if desired.

In many cases, the temporary attachment is provided through the use of a suction cup. However, many surfaces within a vehicle are not conducive to securing a suction cup. These unsuitable surfaces may be textured, curved or otherwise not useful for forming the necessary seal to prevent release of a vacuum necessary for operation of a suction cup.

Until the device and method of the present disclosure, these and other problems in the prior art went either unnoticed or unsolved by those skilled in the art. The present invention provides a base which can perform multiple functions and is capable of use with associated devices without sacrificing portability features, designs, style or affordability.

### SUMMARY OF THE INVENTION

There is disclosed herein an improved mounting device which avoids the disadvantages of prior devices while affording additional structural and operating advantages.

Generally speaking, the device is a base mat for attaching a suction cup mounting device to in a vehicle. The base mat comprises a planar surface made from a substantially rigid material and having first and second faces, first and second foam adhesive strips fixed along edges of the first face of the planar surface, and an optional third foam adhesive strip positioned on the first face of the planar surface between the first and second strips.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a top view of an embodiment of the mounting mat;

FIG. 2 is a top view of an alternate embodiment of the mounting mat;

FIG. 3 is a side edge view of an embodiment of the disclosed mounting mat being positioned on a concave/irregular surface; and

FIG. 4 is a side edge view on an embodiment of the disclosed mounting mat being positioned on a convex/irregular surface.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

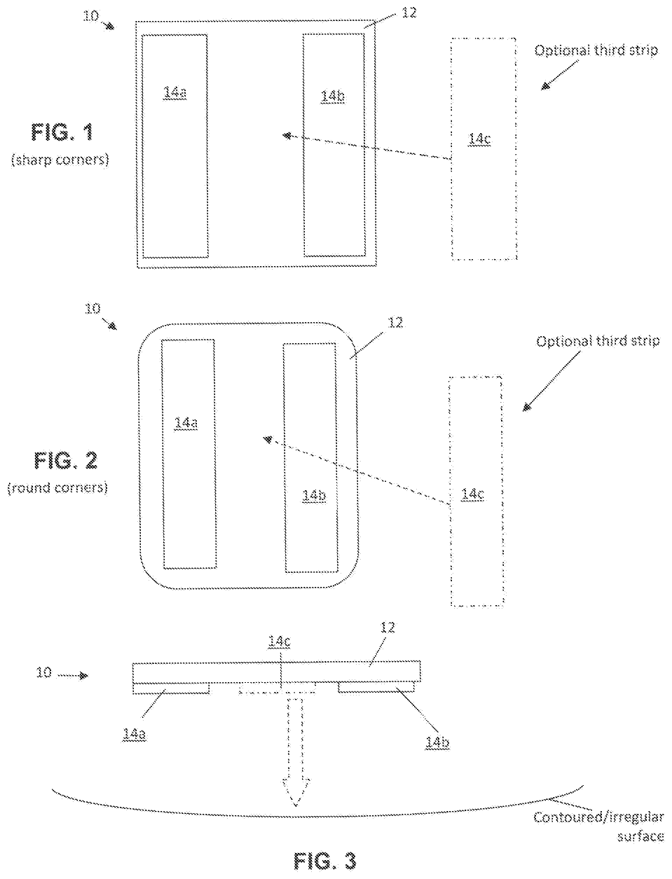

Referring to FIGS. 1-4, there is illustrated a mat, generally designated by the numeral 10. The illustrated mat 10 is for positioning on a surface within, for example, a vehicle to allow attachment of a suction cup mounting device 20. However, it should be understood that the principles of the invention can be more broadly applied to use with other mounting devices, as well as being positioned in other than vehicles—e.g., in work stations, home spaces, study areas, and the like.

As can be seen in FIGS. 1-3, the mat 10 is comprised of a substantially planar body 12 and a plurality of adhesive strips 14. The body 12 is a small, thin, rectangular device with either 90° pointed corners (FIG. 1) or rounded corners (FIG. 2). Preferably, the body 12 is comprised of a somewhat rigid, heat-resistant plastic material which will resist substantial bending, warping and undesirable cracking. The body 12 may be made from most any other type of suitable material that meets the requirements of rigidity (i.e., Shore D hardness of at least 50 and preferably at least 60), heat-resistant (up to at least 200° F.), with a smooth outer surface. Such materials may include metals (e.g., stainless steel), polymers (e.g., HDPE), ceramics, and the like.

In a specific embodiment, the mat 10 includes two adhesive strips 14a,b—preferably foam adhesive strips, such as those made by 3M Company—which are placed proximate the two outer edges of the body 12, as shown. The adhesive strips 14a,b are also preferably heat-resistant to about 200° F. This provides the disclose mat 10 to remain attached to the surface even in extreme heat.

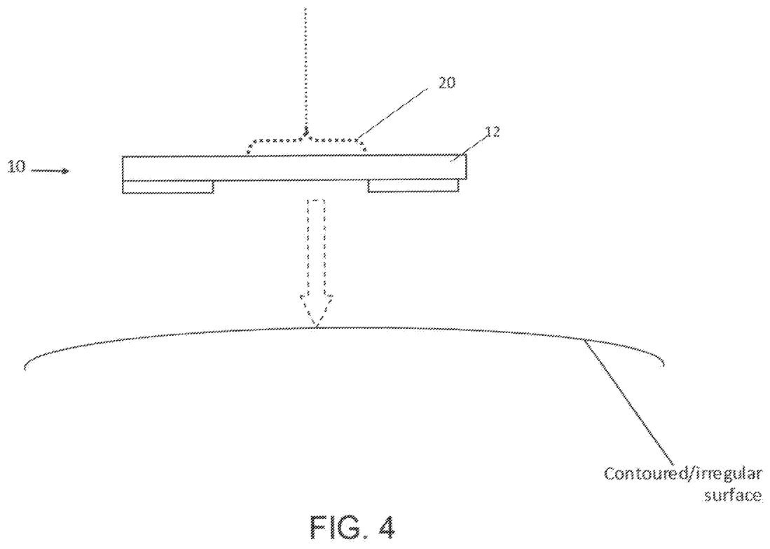

With reference to FIG. 4, this configuration is particularly useful with attachment to a slightly convex surface. In another embodiment, a third optional adhesive strip 14c may be positioned along the center line of the mat 10, if necessary. The third optional strip 14c provides stability when the mat 10 is applied to a slightly curved (concave), textured and/or a non-uniform surface.

Once the mat 10 is secured to a surface, the substantially rigid mat 10 provides an ideal surface for the attachment of a suction cup device 20.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A mat for attachment to a surface to facilitate mounting of a suction cup device, the mat comprising:
a substantially planar body having first and second faces and comprised of a substantially rigid material;
a plurality of foam adhesive strips fixed proximate edges of the first face of the planar body.

2. The mat of claim 1, wherein the number of foam adhesive strips is two.

3. The mat of claim 1, wherein the number of foam adhesive strips is three.

4. The mat of claim 2, further comprising a third foam adhesive strip fixed between the two adhesive strips on the first face of the planar body.

5. The mat of claim 1, wherein the planar body is comprised of a rigid plastic material.

6. The mat of claim 1, wherein the plurality of foam adhesive strips can adhere to a contoured surface.

7. The mat of claim 1, wherein the plurality of foam adhesive strips can adhere the planar body to either an irregular or textured surface.

8. The mat of claim 1, wherein the planar body is comprised of a heat-resistant material.

9. The mat of claim 8, wherein the heat-resistant material resists distortion at a temperature of about 200 degrees Fahrenheit.

10. The mat of claim 1, wherein the plurality of foam adhesive strips resist distortion up to a temperature of about 200 degrees Fahrenheit.
